(19) United States
(12) Patent Application Publication
(10) Pub. No.: US 2021/0292236 A1
(43) Pub. Date: Sep. 23, 2021

(54) REINFORCED AND TOUGHENED MGO SUBSTRATE, PREPARATION METHOD THEREOF AND COMPOSITE BOARD HAVING THE SUBSTRATE

(71) Applicant: JIANGSU LANGYUE NEW MATERIALS TECHNOLOGY CO., LTD., Jiangsu (CN)

(72) Inventor: Guoping LI, Jiangsu (CN)

(73) Assignee: JIANGSU LANGYUE NEW MATERIALS TECHNOLOGY CO., LTD., Jiangsu (CN)

(21) Appl. No.: 17/004,016

(22) Filed: Aug. 27, 2020

Related U.S. Application Data
(63) Continuation of application No. PCT/CN2020/080147, filed on Mar. 19, 2020.

(51) Int. Cl. C04B 28/10; C04B 40/02; C04B 16/06; C04B 16/12; C04B 16/02; C04B 18/24

(52) U.S. Cl. CPC C04B 28/105; C04B 40/0281; C04B 16/06; C04B 2111/2038; C04B 16/02; C04B 18/24; C04B 16/12

(57) ABSTRACT

The present application discloses a reinforced and toughened MGO substrate, a preparation method thereof and a composite board having the substrate. The reinforced and toughened MGO substrate includes a middle layer and fiber layers on upper and lower surfaces of the middle layer, wherein the fiber layers are glassfiber surface mats, and the middle layer is prepared from a forming agent, a lightweight filler, a modifier and water in parts by weight as follows: 34-45 parts of light burned magnesium oxide, 23-30 parts of magnesium sulfate heptahydrate, 8-10 parts of granulated lignocellulose, 4-6 parts of xylem fiber, 0.5-2 parts of the modifier, and 18-26 parts of water; the modifier being obtained by mixing citric acid, anhydrous sodium sulfate, dihydrogen phosphate and phosphoric acid in a mass ratio of 10:3:1:6.

### CROSS-REFERENCE TO RELATED APPLICATION

This application is a continuation of international PCT application serial no. PCT/CN2020/080147 filed on Mar. 19, 2020. The entirety of the above-mentioned patent application is incorporated herein by reference and made a part of this specification.

### BACKGROUND OF THE INVENTION

### 1. Technical Field

The present application relates to the field of decorative materials, in particular to a reinforced and toughened MGO substrate, a preparation method thereof and a composite board having the substrate.

### 2. Background Art

A magnesium oxide fireproof board is also called an MGO board, a magnesium oxide board, a magnesite board or a magnesium board. Components for preparing the magnesium oxide fireproof board include active high-purity magnesium oxide (MgO), high-quality magnesium chloride (MgCl₂), alkali-resistant glassfiber fabrics, plant fiber, incombustible lightweight perlite, chemically stable lithopone, high-molecular polymers and high-performance modifiers.

At present, Chinese Patent No. CN101871246B discloses an MGO board, which is prepared from a forming agent, a reinforcing material, a lightweight filler, a modifier and water, wherein the forming agent is magnesium oxide, magnesium sulfate and magnesium chloride, the reinforcing material is glassfiber mesh fabric or other reinforcing materials, and the modifier includes a whitening agent, a stabilizer and a toner.

In the above existing technical solution, glassfiber mesh fabric is used as the reinforcing material, and due to the excellent toughness of glassfiber mesh fabric, the internal bonding strength is low when glassfiber mesh fabric is combined with other materials; and when the MGO board is slotted from the outside during mounting, peeling may easily occur at the slotted position of the MGO board subjected to a shearing force and cause cracking at the opening of the slot, thus influencing the practicability of the MGO board.

### SUMMARY OF THE INVENTION

In view of the defects present in the prior art, the present application provides a reinforced and toughened MGO substrate, which is advantageous by having high internal bonding strength, high bending strength and high screw holding capability and being not prone to peeling and cracking.

In a first aspect, the present application provides the following technical solution: a reinforced and toughened MGO substrate, including a middle layer and fiber layers on upper and lower surfaces of the middle layer, wherein the fiber layers are glassfiber surface mats, and the middle layer is prepared from a forming agent, a lightweight filler, a modifier and water in parts by weight as follows: 34-45 parts of light burned magnesium oxide, 23-30 parts of magnesium sulfate heptahydrate, 8-10 parts of granulated lignocellulose, 4-6 parts of xylem fiber, 0.5-2 parts of the modifier, and 18-26 parts of water; the modifier being obtained by mixing citric acid, anhydrous sodium sulfate, dihydrogen phosphate and phosphoric acid in a mass ratio of 10:3:1:6.

By adopting the above technical solution, magnesium oxide and magnesium sulfate heptahydrate are used as the forming agent which is the basic raw material for preparing the MGO substrate; granulated lignocellulose and xylem fiber are used as the lightweight filler, by which on one hand, the weight of the substrate can be reduced, and on the other hand, the screw holding capability of the substrate can be improved. In addition, the modifier is added into the MGO substrate, so that the surface properties of the substrate are improved, and bubbles inside and on the surface of the substrate are reduced, thereby improving the internal bonding strength of the substrate. Glassfiber surface mats are used as a reinforcing material, and surface fibers in the glassfiber mats are uniformly distributed, so that the surface structure of the substrate is very compact, thereby further improving the bending strength of the substrate and the property of the substrate of being not prone to peeling and cracking; and citric acid, anhydrous sodium sulphate, dihydrogen phosphate and phosphoric acid in the modifier are all dissolvable in water and have good stability, so that the generation of bubbles is reduced, and the internal bonding strength of the substrate is enhanced.

Further, the dihydrogen phosphate is any one of magnesium dihydrogen phosphate and sodium dihydrogen phosphate.

By adopting the above technical solution, the generation of bubbles is further reduced, and the internal bonding strength of the substrate is enhanced.

Further, the light burned magnesium oxide has a content of magnesium oxide of >85% and a content of reactive magnesium oxide of >65%.

By adopting the above technical solution, the rate of preparation is increased, and the use amount of light burned magnesium oxide is saved, so that the production cost is reduced.

Further, the granulated lignocellulose has a fineness of 20-60 mesh and a moisture content of 0.5-10%, and the xylem fiber has a fiber length of 3-12 mm and a moisture content of 0.5-10%.

By adopting the above technical solution, the selected granulated lignocellulose with such fineness and xylem fiber with such length can disperse well in magnesium oxysulfate cement, and can be easily and uniformly mixed with other components in magnesium oxysulfate cement; and the selected granulated lignocellulose and xylem fiber with such moisture content allow the moisture content of the substrate to be ensured, thereby improving the internal bonding strength of the substrate.

Further, the glassfiber mat is an alkali-free glassfiber surface mat which is formed by bonding randomly oriented glassfiber filaments with resin and curing, and the glassfiber filaments have a mass content of 30-100 g/m² and a length of >50 mm.

By adopting the above technical solution, the substrate is provided with a compact surface structure, and the compressive strength of the substrate is improved; and as glassfiber filaments in the alkali-free fiber surface mat are randomly distributed, the strength of the alkali-free glassfiber surface mat is equal in all directions, and the property of the substrate of being not prone to peeling and cracking is improved.

In a second aspect, the present application provides a preparation method of the reinforced and toughened MGO substrate, which is advantageous by providing simplicity in preparation, reducing bubbles generated in magnesium oxysulfate cement during preparation, improving the internal bonding strength of the substrate and effectively ensuring the quality of the substrate.

In particular, the present application provides the following technical solution: a preparation method of the reinforced and toughened MGO substrate, including the following steps of:

S1, uniformly stirring magnesium sulfate heptahydrate with water to obtain a magnesium sulfate heptahydrate solution;

S2, uniformly blending and stirring light burned magnesium oxide with the magnesium sulfate heptahydrate solution prepared in the step S1, and then sequentially adding a modifier, granulated lignocellulose and xylem fiber, and performing stirring for mixing to obtain magnesium oxysulfate cement;

S3, laying a glassfiber surface mat into a mold, spreading the magnesium oxysulfate cement prepared in the step S2 onto the glassfiber surface mat, performing flattening, laying another glassfiber surface mat on the surface of magnesium oxysulfate cement, performing flattening until the surface of the glassfiber mat is uniformly permeated by a slurry, and putting the obtained material in a curing room with a temperature of 20-30° C. and a humidity of 40-60% for 2-6 h to obtain a primary cured semi-finished product;

S4, taking out the primary cured semi-finished product prepared in the step S3 from the curing room, performing flattening and exhausting; and taking out and putting the flattened and exhausted primary cured semi-finished product in a curing room with a temperature of 20-25° C. and a humidity of 40-50% for 3-5 days to obtain a secondary cured semi-finished product; and

S5, taking out the secondary cured semi-finished product prepared in the step S4 from the curing room, and performing trimming, cutting and polishing; and then putting the polished secondary cured semi-finished product in a curing room with a temperature of 20-25° C. and a humidity of 40-50% for 5-12 days to obtain a shaped substrate.

By adopting the above technical solution, the sequence of adding the raw materials is strictly controlled, so that uniform dispersion of light burned magnesium oxide, magnesium sulfate heptahydrate, the modifier, granulated lignocellulose and xylem fiber can be ensured, and the internal binding force of the substrate layer of the composite board is improved; then, bubbles in magnesium oxysulfate cement are further reduced by the process of flattening and exhausting for multiple times, so that the internal bonding strength of the substrate is effectively improved. Meanwhile, with the three times of curing, reaction and shaping of the magnesium oxysulfate cement is provided with sufficient time, so that the quality of the substrate is effectively guaranteed.

In a third aspect, the present application is to provide a reinforced and toughened MGO composite board, which is advantageous by having a wide application range and further improving the compressive strength, impact strength and screw holding capability of the substrate.

In particular, the present application provides the following technical solution: a reinforced toughened MGO composite board, including a surface layer and a substrate, wherein the surface layer is bonded onto the substrate with an adhesive and cured, and the surface layer is any one of marble, wood veneer and a fireproof board.

By adopting the above technical solution, when the surface layer is made from marble, the utilization of marble resources is increased; meanwhile, marble is prepared into the composite board, so that the problems of low construction speed, frangibility and cracking of marble are solved. When the surface layer is made from wood veneer, a composite wood floor board can be prepared, and by virtue of the glassfiber surface mat of the substrate, the influence of humidity on the composite wood floor board, which causes warping of the wood floor board, is greatly reduced. When the surface layer is a fireproof board, a composite fireproof board can be prepared, and the composite board has an ultra-high dimensional stability and is not prone to cracking. The composite board can be quickly mounted into wallboards, floors and ceilings after being slotted, and is applicable to cold and dry areas, providing a high fire rating.

Further, the fireproof board is prepared by the following steps of: immersing a glassfiber surface mat in resin for 120-150 min, taking out the glassfiber surface mat and performing hot-press molding on the glassfiber surface mat with melamine decorative paper under a temperature of 130-170° C. and a pressure of 10-21 MPa.

By adopting the above technical solution, the fireproof board has the advantages such as light weight, high strength, good durability and convenience in construction, and the strength of the prepared fireproof board is allowed to be equal in all directions with the glassfiber surface mat, so that the decorative surface of the whole fireproof board is not easy to deform, and therefore the property of the entire composite board of being not prone to peeling and cracking is effectively improved.

Further, the fireproof board is prepared by the following steps of: immersing non-woven fabric in resin for 120-150 min, taking out the non-woven fabric and performing hot-press molding on the non-woven fabric with melamine decorative paper under a temperature of 130-170° C. and a pressure of 10-21 MPa.

By adopting the above technical solution, the fireproof board is simple in preparation, and the strength of the decorative surface of the fireproof board is enhanced by the non-woven fabric, so that the strength of the prepared fireproof board is equal in all directions, and the property of the entire composite board of being not prone to peeling and cracking is effectively improved.

By adopting the above technical solution, both melamine resin and urea-formaldehyde resin have high heat resistance and moisture resistance, and the moisture resistance of the entire composite board is further improved.

Further, the resin includes one or both of melamine resin and urea-formaldehyde resin.

By adopting the above technical solution, both melamine resin and urea-formaldehyde resin have high heat resistance and moisture resistance, and the moisture resistance of the entire composite board is further improved.

In summary, the present application has the following beneficial effects:

firstly, as the modifier is preferably used in the present application, bubbles in magnesium oxysulfate cement are further reduced, and the internal bonding strength of the substrate is effectively improved;

secondly, alkali-free glassfiber surface mats are preferably used in the present application, so that the mechanical strength of the substrate is enhanced; and

thirdly, the MGO substrate prepared in the present application can be combined with various surface layers, so that the mechanical properties, such as compressive strength, impact strength and screw holding capability, of the entire composite board are improved.

### DETAINED DESCRIPTION OF THE INVENTION

The present application will now be described in further detail with reference to the embodiments.

Sources of raw materials: see Table 1 below.

TABLE 1
Sources and Specifications of Raw Materials of
Reinforced and Toughened MGO Composite Board

| Raw material | Source | Specifications | Origin |
|---|---|---|---|
| Forming | Light burned | Content of magnesium | Yingkou Xinyao |
| agent | magnesium oxide | oxide 85%, | Magnesium |
| | | content of reactive | |
| | | magnesium | |
| | | oxide 80%. | |
| | Magnesium sulfate | Purity 99% | Weifang Dakang |
| | heptahydrate | | Chemical |
| Lightweight | Poplar wood powder | Fineness 20-60 mesh, | Wuxi Simude |
| filler | | moisture | |
| | | content 0.5-10%. | |
| | Lignocellulose | Fiber length 5 mm, | Wuxi Simude |
| | | moisture | |
| | | content 0.5-10%. | |
| Modifier | Citric acid | Purity 99% | Shandong |
| | monohydrate | | Ruisheng |
| | Anhydrous sodium | Sodium sulphate | Zibo Huayan |
| | sulphate | purity 99% | |
| | Magnesium | Purity 99% | He'nan |
| | dihydrogen phosphate | | Hongkang |
| | Sodium dihydrogen | Purity 99% | He'nan |
| | phosphate | | Hongkang |
| | Phosphoric acid | Industrial | Nantong |
| | | grade 85% | Shuangxian Fine |
| Resin | Melamine resin | Purity 99.8% | Jining Hongming |
| | Urea-formaldehyde | Molecular | Kedi Chemical |
| | resin | weight 90.08 | |
| | Alkali-free glassfiber | Gram weight per | Sinoma Science |
| | surface mat | square 50 g/m² | & Technology |
| | Polyurethane adhesive | CR361 | Jilin Zhengqi |
| | Marble | 2600*2000*1600 | Shiyan Tianci |
| | Yellow poplar veneer | Thickness 0.6 mm | Guangzhou |
| | | | Huayuan |
| | Non-woven fabric | Gram weight per | Guangzhou |
| | | square 50 g/m² | Jingjin |
| | Melamine decorative | Weight per square | Hangzhou |
| | paper | meter 30 g | Lin'an |
| | | | Clean |

A BY214*8/E series multi-ply plywood hot press was selected and purchased from Linyi Lanshan District Jianye Machinery Factory (Linyi Lanshan District Jianye Shunda Machinery Co., Ltd.); and

a PG02 series CNC slotting machine (self-digging machine) was purchased from Shanghai Eternal Co., Ltd.

### EXAMPLES

The components and formulations of various Examples are shown in Table 2.

TABLE 2
Components and Formulations of Reinforced and Toughened MGO Substrates in Various Examples:

| Component | Example 1 | | Example 2 | | Example 3 | | Example 4 | | Example 5 | | Example 6 | |
|---|---|---|---|---|---|---|---|---|---|---|---|---|
| Light burned | 34 | kg | 40 | kg | 45 | kg | 40 | kg | 40 | kg | 40 | kg |
| magnesium | | | | | | | | | | | | |
| oxide | | | | | | | | | | | | |
| Magnesium | 23 | kg | 27 | kg | 30 | kg | 27 | kg | 27 | kg | 27 | kg |
| sulfate | | | | | | | | | | | | |
| heptahydrate | | | | | | | | | | | | |
| Poplar wood | 8 | kg | 9 | kg | 10 | kg | 9 | kg | 9 | kg | 9 | kg |
| powder | | | | | | | | | | | | |
| Lignocellulose | 4 | kg | 5 | kg | 6 | kg | 5 | kg | 5 | kg | 5 | kg |
| Citric acid | 0.5 | kg | 1.25 | kg | 2 | kg | 1.25 | kg | 1.25 | kg | 1.25 | kg |
| monohydrate | (citric acid | | (citric acid | | (citric acid | | (citric acid | | (citric acid | | (citric acid | |
| Anhydrous | monohydrate: | | monohydrate: | | monohydrate: | | monohydrate: | | monohydrate: | | monohydrate: | |
| sodium | anhydrous | | anhydrous | | anhydrous | | anhydrous | | anhydrous | | anhydrous | |
| sulphate | sodium | | sodium | | sodium | | sodium | | sodium | | sodium | |
| Magnesium | sulfate: | | sulfate: | | sulfate: | | sulfate: | | sulfate: | | sulfate: | |
| dihydrogen | magnesium | | magnesium | | magnesium | | magnesium | | magnesium | | magnesium | |
| phosphate | dihydrogen | | dihydrogen | | dihydrogen | | dihydrogen | | dihydrogen | | dihydrogen | |
| Sodium | phosphate: | | phosphate: | | phosphate: | | phosphate: | | phosphate: | | phosphate: | |
| dihydrogen | phosphoric | | phosphoric | | phosphoric | | phosphoric | | phosphoric | | phosphoric | |
| phosphate | acid = | | acid = | | acid = | | acid = | | acid = | | acid = | |
| Phosphoric | 10:3:1:6) | | 10:3:1:6) | | 10:3:1:6) | | 10:3:1:6) | | 10:3:1:6) | | 10:3:1:6) | |
| acid | | | | | | | | | | | | |
| Water | 18 | kg | 22.5 | kg | 26 | kg | 22.5 | kg | 22.5 | kg | 22.5 | kg |
| Moisture | 6.00% | | 6.00% | | 6.00% | | 6.00% | | 6.00% | | 6.00% | |
| content of | | | | | | | | | | | | |
| poplar wood | | | | | | | | | | | | |
| powder (%) | | | | | | | | | | | | |
| Fineness of | 40 | mesh | 40 | mesh | 40 | mesh | 20 | mesh | 60 | mesh | 40 | mesh |
| poplar wood | | | | | | | | | | | | |
| powder | | | | | | | | | | | | |
| (mesh) | | | | | | | | | | | | |

| | | | | | | |
|---|---|---|---|---|---|---|
| Time, | 270 min, | 270 min, | 270 min, | 270 min, | 270 min, | 120 min, |
| temperature | 25° C., 50% | 25° C., 50% | 25° C., 50% | 25° C., 50% | 25° C., 50% | 25° C., 50% |
| and humidity | | | | | | |
| of first curing | | | | | | |
| Time, | 4 days, | 4 days, | 4 days, | 4 days, | 4 days, | 4 days, |
| temperature | 27° C., 45% | 27° C., 45% | 27° C., 45% | 27° C., 45% | 27° C., 45% | 27° C., 45% |
| and humidity | | | | | | |
| of second | | | | | | |
| curing | | | | | | |
| (day) | | | | | | |
| Time, | 9 days, | 9 days, | 9 days, | 9 days, | 9 days, | 9 days, |
| temperature | 27° C., 45% | 27° C., 45% | 27° C., 45% | 27° C., 45% | 27° C., 45% | 27° C., 45% |
| and humidity | | | | | | |
| of third curing | | | | | | |
| (day) | | | | | | |

| | |
|---|---|
| Alkali-free | Gram weight per square 50 g/m² |
| glassfiber | |
| surface mat | |

| Component | Example 7 | | Example 8 | | Example 9 | | Example 10 | | Example 11 | |
|---|---|---|---|---|---|---|---|---|---|---|
| Light burned | 40 | kg | 40 | kg | 40 | kg | 40 | kg | 40 | kg |
| magnesium | | | | | | | | | | |
| oxide | | | | | | | | | | |
| Magnesium | 27 | kg | 27 | kg | 27 | kg | 27 | kg | 27 | kg |
| sulfate | | | | | | | | | | |
| heptahydrate | | | | | | | | | | |
| Poplar wood | 9 | kg | 9 | kg | 9 | kg | 9 | kg | 9 | kg |
| powder | | | | | | | | | | |
| Lignocellulose | 5 | kg | 5 | kg | 5 | kg | 5 | kg | 5 | kg |
| Citric acid | 1.25 | kg | 1.25 | kg | 1.25 | kg | 1.25 | kg | 1.25 | kg |

| | | | | | |
|---|---|---|---|---|---|
| monohydrate | (citric acid | (citric acid | (citric acid | (citric acid | (citric acid |
| Anhydrous | monohydrate: | monohydrate: | monohydrate: | monohydrate: | monohydrate: |
| sodium | anhydrous | anhydrous | anhydrous | anhydrous | anhydrous |
| sulphate | sodium | sodium | sodium | sodium | sodium |
| Magnesium | sulfate: | sulfate: | sulfate: | sulfate: | sulfate: |
| dihydrogen | magnesium | magnesium | magnesium | magnesium | magnesium |
| phosphate | dihydrogen | dihydrogen | dihydrogen | dihydrogen | dihydrogen |
| Sodium | phosphate: | phosphate: | phosphate: | phosphate: | phosphate: |
| dihydrogen | phosphoric | phosphoric | phosphoric | phosphoric | phosphoric |
| phosphate | acid = | acid = | acid = | acid = | acid = |
| Phosphoric | 10:3:1:6) | 10:3:1:6) | 10:3:1:6) | 10:3:1:6) | 10:3:1:6) |
| acid | | | | | |

| | | | | | | | | | | |
|---|---|---|---|---|---|---|---|---|---|---|
| Water | 22.5 | kg | 22.5 | kg | 22.5 | kg | 22.5 | kg | 22.5 | kg |

| | | | | | |
|---|---|---|---|---|---|
| Moisture | 6.00% | 6.00% | 6.00% | 0.5% | 10% |
| content of | | | | | |
| poplar wood | | | | | |
| powder (%) | | | | | |

| | | | | | | | | | | |
|---|---|---|---|---|---|---|---|---|---|---|
| Fineness of | 40 | mesh | 40 | mesh | 40 | mesh | 40 | mesh | 40 | mesh |
| poplar wood | | | | | | | | | | |
| powder (mesh) | | | | | | | | | | |

| | | | | | |
|---|---|---|---|---|---|
| Time, | 360 min, | 270 min, | 270 min, | 270 min, | 270 min, |
| temperature | 25° C., 50% | 20° C., 40% | 30° C., 60% | 25° C., 50% | 25° C., 50% |
| and humidity | | | | | |
| of first curing | | | | | |
| (min) | | | | | |
| Time, | 4 days, | 4 days, | 4 days, | 4 days, | 4 days, |
| temperature | 27° C., 45% | 25° C., 40% | 30° C., 50% | 27° C., 45% | 27° C., 45% |
| and humidity | | | | | |
| of second | | | | | |
| curing | | | | | |
| (day) | | | | | |
| Time, | 9 days, | 9 days, | 9 days, | 9 days, | 9 days, |
| temperature | 27° C., 45% | 25° C., 40% | 30° C., 50% | 27° C., 45% | 27° C., 45% |
| and humidity | | | | | |
| of third curing | | | | | |
| (day) | | | | | |

| | |
|---|---|
| Alkali-free | Gram weight per square 50 g/m² |
| glassfiber | |
| surface mat | |

Each of the reinforced and toughened MGO substrates of Examples 1-11 above was prepared as follows:

S1, an alkali-free glassfiber surface mat according to Table 2 was laid and flattened, and the alkali-free glassfiber surface mat was cut according to a mold size of 2440*1220;

S2, a magnesium sulfate solution was prepared by firstly adding magnesium sulfate heptahydrate in parts by weight according to Table 2 into water, and performing uniform stirring to obtain the magnesium sulfate solution;

S3, magnesium oxysulfate cement was prepared by uniformly blending and stirring light burned magnesium oxide in parts by weight according to Table 2 with the magnesium sulfate solution prepared in S2, adding a modifier and performing uniform stirring to form a mixture slurry, sequentially adding poplar wood powder and xylem fiber in parts by weight according to Table 2 into the mixture slurry and performing uniform stirring, and performing exhausting with a vibration pump to obtain magnesium oxysulfate cement;

S4, a primary cured semi-finished product was prepared with a mold by laying the alkali-free glassfiber surface mat cut in S1 in the mold at normal temperature, spreading magnesium oxysulfate cement prepared in the step S3 onto the glassfiber surface mat, performing flattening with a constant-thickness roller, performing exhausting with the vibration pump during conveying, laying another glassfiber surface mat on the surface of magnesium oxysulfate cement, and performing flattening to make the surface of the alkali-free glassfiber felt uniformly permeated by the slurry; and removing the mold, and putting the obtained material in a curing room with a temperature, humidity and time according to Table 2 to obtain the preliminary cured semi-finished product;

S5, a secondary cured semi-finished product was prepared by taking out the preliminary cured semi-finished product prepared in S4 from the curing room, and performing flattening and exhausting; and then putting the flattened and exhausted primary cured semi-finished product in a curing room with a temperature, humidity and time according to Table 2 to obtain the secondary cured semi-finished product; and

S6, a substrate was obtained through final shaping by taking out the secondary cured semi-finished product prepared in S5 from the curing room, and performing trimming, cutting and polishing; and then putting the polished secondary cured semi-finished product in a curing room with a temperature, humidity and time according to Table 2 to obtain the substrate.

The properties of the reinforced and toughened MGO substrates prepared in the above Examples were tested by using the following method.

Apparent properties: including both before and after screw holding capability tests; MGO substrate or composite board standard test blocks were subjected to microscopic detection with a scanning electron microscope and observed for surface cracking.

Compressive strength and apparent density were tested according to JC688-2006 “Glass fiber & magnesium cement board”.

Impact strength: tests were carried out referring to an impact strength determination method in GB/T1043.1 “Plastics-Determination of Charpy impact properties-Part 1: Non-instrumented impact test”.

Dehalogenation resistance: referring to JC688-2006 “Glass fiber & magnesium cement board”, one piece of 200 mm*200 mm was randomly cut from each of three boards in a set of samples, and was put into a constant temperature and humidity box with a relative humidity of greater than or equal to 90% and a temperature of 30° C.-35° C., and after 24 hours, the samples were taken out and observed for the presence or absence of water drops or damping.

Determination of screw holding capability: referring to JC688-2006 “Glass fiber & magnesium cement board”, one piece of 50 mm*50 mm was randomly cut from each of three boards in a set of samples, a hole with a diameter of 3.2 mm was drilled at the intersection of diagonal lines of each sample with a bench drill in advance, and then a wood screw was screwed vertically into a depth of 10 mm±1 mm protruding from the opposite side without hammering, then the wood screw was pulled out with a loading speed of 50 N/S, and a limit load value was recorded.

Determination after slotting: referring to JC688-2006 “Glass fiber & magnesium cement board”, one piece of 300 mm*300 mm was randomly cut from each of three boards in a set of samples, side edges of diagonal corners of the samples were slotted with the CNC slotting machine, the slots were formed towards the inner depth of the samples at a speed of 50 N/S until peeling and cracking of the samples occurred, and the slotting depths at which peeling and cracking of the samples occurred were recorded.

Abrasion resistance test: evaluation was carried out according to GB/T18301-2012 “Refractory products-Determination of resistance to abrasion at ambient temperature”.

Refractory performance test: evaluation was carried out according to JC688-2006 “Glass fiber & magnesium cement board” and GB/T8624-1997 “Classification of burning behavior of building materials and products”.

TABLE 3
Test Results of Substrates of Reinforced and Toughened MGO Composite Boards

| | | | | | | Screw | |
|---|---|---|---|---|---|---|---|
| | | | | | | holding | |
| Detection | Apparent | Apparent | Bending | Impact | | capability | Slotting |
| item | morphology | density | strength | strength | Dehalogenation | of board | depth |
| Example 1 | No cracking | 1.33 t/m³ | 33 MPa | 21 kJ/m² | No water drops, | 37 N/m | 160 mm |
| | | | | | no damping | | |
| Example 2 | No cracking | 1.37 t/m³ | 36 MPa | 25 kJ/m² | No water drops, | 41 N/m | 175 mm |
| | | | | | no damping | | |
| Example 3 | No cracking | 1.35 t/m³ | 34 MPa | 23 kJ/m² | No water drops, | 39 N/m | 162 mm |
| | | | | | no damping | | |
| Example 4 | No cracking | 1.31 t/m³ | 33 MPa | 22 kJ/m² | No water drops, | 37 N/m | 156 mm |
| | | | | | no damping | | |
| Example 5 | No cracking | 1.36 t/m³ | 35 MPa | 25 kJ/m² | No water drops, | 38 N/m | 168 mm |
| | | | | | no damping | | |
| Example 6 | No cracking | 1.32 t/m³ | 31 MPa | 20 kJ/m² | No water drops, | 35 N/m | 164 mm |
| | | | | | no damping | | |
| Example 7 | No cracking | 1.34 t/m³ | 33 MPa | 23 kJ/m² | No water drops, | 37 N/m | 161 mm |
| | | | | | no damping | | |
| Example 8 | No cracking | 1.33 t/m³ | 36 MPa | 22 kJ/m² | No water drops, | 38 N/m | 163 mm |
| | | | | | no damping | | |
| Example 9 | No cracking | 1.37 t/m³ | 35 MPa | 26 kJ/m² | No water drops, | 38 N/m | 167 mm |
| | | | | | no damping | | |
| Example 10 | No cracking | 1.34 t/m³ | 33 MPa | 27 kJ/m² | No water drops, | 36 N/m | 165 mm |
| | | | | | no damping | | |
| Example 11 | No cracking | 1.32 t/m³ | 31 MPa | 25 kJ/m² | No water drops, | 35 N/m | 160 mm |
| | | | | | no damping | | |

The reinforced and toughened MGO substrates prepared according to the above formulations have no cracking on the surface with an apparent density of 1.31-1.38 t/m³, and due to the fact that the smaller the porosity of the reinforced and toughened MGO substrate is, the higher the compactness of the substrate is, the internal bonding strength of the substrates is high. Besides, the slotting depths at which peeling and cracking of the samples occurred in the above-mentioned Examples 1 to 11 is in the range of 160 to 175 mm.

### COMPARATIVE EXAMPLES

The components and formulations of reinforced and toughened MGO substrates prepared in comparative examples are shown in Table 4.

TABLE 4
Components and Formulations of Reinforced and Toughened MGO Substrates In Comparative Examples 1-4

| | Comparative | | Comparative | | Comparative | | Comparative | |
|---|---|---|---|---|---|---|---|---|
| Components/part | Example 1 | | Example 2 | | Example 3 | | Example 4 | |
| Light burned | 40 | kg | 40 | kg | 40 | kg | 40 | kg |
| magnesium oxide | | | | | | | | |
| Magnesium sulfate | 27 | kg | 27 | kg | 27 | kg | 27 | kg |
| heptahydrate | | | | | | | | |
| Poplar wood powder | 9 | kg | 9 | kg | 9 | kg | 9 | kg |
| Lignocellulose | 5 | kg | 5 | kg | 5 | kg | 5 | kg |
| Citric acid | 0 | kg | 1.25 kg (citric | | 1.25 kg (citric | | 1.25 kg (citric | |
| monohydrate | | | acid | | acid | | acid | |
| Anhydrous sodium | | | monohydrate:anhydrous | | monohydrate:anhydrous | | monohydrate:anhydrous | |
| sulphate | | | sodium | | sodium | | sodium | |
| Magnesium | | | sulfate:magnesium | | sulfate:magnesium | | sulfate:magnesium | |
| dihydrogen | | | dihydrogen | | dihydrogen | | dihydrogen | |
| phosphate | | | phosphate:phosphoric | | phosphate:phosphoric | | phosphate:phosphoric | |
| Sodium dihydrogen | | | acid = | | acid = | | acid = | |
| phosphate | | | 8:5:1:6) | | 12:1:1:6) | | 10:3:2:5) | |
| Phosphoric acid | | | | | | | | |
| Water | 22.5 | kg | 22.5 | kg | 22.5 | kg | 22.5 | kg |
| Moisture content of | 6.00% | | 6.00% | | 6.00% | | 6.00% | |
| poplar wood powder | | | | | | | | |
| (%) | | | | | | | | |
| Fineness of poplar | 40 | mesh | 40 | mesh | 40 | mesh | 40 | mesh |
| wood powder | | | | | | | | |
| (mesh) | | | | | | | | |

| | | | | |
|---|---|---|---|---|
| Time, temperature and | 270 min, | 270 min, | 270 min, | 270 min, |
| humidity of first | 25° C., | 25° C., | 25° C., | 25° C., |
| curing | 50% | 50% | 50% | 50% |
| Time, temperature and | 4 days, | 4 days, | 4 days, | 4 days, |
| humidity of second | 27° C., | 27° C., | 27° C., | 27° C., |
| curing | 45% | 45% | 45% | 45% |
| Time, temperature and | 9 days, | 9 days, | 9 days, | 9 days, |
| humidity of third | 27° C., | 27° C., | 27° C., | 27° C., |
| curing | 45% | 45% | 45% | 45% |

| | |
|---|---|
| Alkali-free glassfiber | Gram weight per square 50 g/m² |
| surface mat | |

Compared with Example 2, Comparative Example 1 was not added with a modifier; and Comparative Examples 2, 3 and 4 were added with modifiers in different mass proportions.

### Comparative Example 5

An MGO board purchased from Zhangjiagang Leader Import and Export Co., Ltd. was compared with the substrate manufactured according to the present application; and the components for preparing the purchased MGO board include active magnesium oxide, high-quality magnesium chloride, alkali-resistant glassfiber fabrics, plant fiber, incombustible lightweight perlite, chemically stable lithopone, high-molecular polymers and high-performance modifiers.

### Comparative Example 6

An MGO board purchased from Zhangjiagang Shitai Building Materials Co., Ltd. was compared with the substrate manufactured according to the present application; and the components for preparing the purchased MGO board include active magnesium oxide, high-quality magnesium chloride, alkali-resistant glassfiber fabrics, excellent-flexibility plant fiber, incombustible lightweight perlite, high-molecular polymers and high-performance modifiers.

The reinforced and toughened MGO substrates obtained in the above Comparative Examples 1 to 4 were prepared with the same method as in the Examples, and Comparative Examples 4 and 5 were purchased from the market. Test results of the reinforced and toughened MGO substrates prepared in the above Comparative Examples 1 to 6 are shown in Table 5.

TABLE 5
Test Results of Properties of Reinforced and Toughened
MGO Substrates Prepared in Comparative Examples

| | | | | | | Screw | | |
|---|---|---|---|---|---|---|---|---|
| | | | | | | holding | | |
| Detection | Apparent | Apparent | Bending | Impact | | capability | Slotting | |
| item | morphology | density | strength | strength | Dehalogenation | of board | depth | |
| Comparative | With | 1.06 t/m³ | 14 MPa | 11 kJ/m² | No water drops, | 22 N/m | 95 | mm |
| Example 1 | cracking | | | | no damping | | | |
| Comparative | No cracking | 1.18 t/m³ | 25 MPa | 13 kJ/m² | No water drops, | 26 N/m | 142 | mm |
| Example 2 | | | | | no damping | | | |
| Comparative | No cracking | 1.20 t/m³ | 28 MPa | 15 kJ/m² | With water drops | 27 N/m | 141 | mm |
| Example 3 | | | | | and damping | | | |
| Comparative | No cracking | 1.21 t/m³ | 27 MPa | 18 kJ/m² | No water drops, | 25 N/m | 144 | mm |
| Example 4 | | | | | no damping | | | |
| Comparative | No cracking | 1.04 t/m³ | 16 MPa | 12 kJ/m² | No water drops, | 21 N/m | 124 | mm |
| Example 5 | | | | | no damping | | | |
| Comparative | No cracking | 1.06 t/m³ | 22 MPa | 14 kJ/m² | No water drops, | 24 N/m | 126 | mm |
| Example 6 | | | | | no damping | | | |

As can be seen from the above data, when no modifier is added or a modifier is added in an excessive amount or a small amount, small bubbles may be unstably generated during preparation of magnesium oxysulfate cement, and may easily fuse with each other to from large pores, such that the slotting depth is greatly reduced, and the phenomenon of peeling and cracking easily occurs when the substrate is mounted.

Examples of reinforced and toughened MGO composite board

### Example 8

A reinforced and toughened MGO composite board included a surface layer and a substrate, and marble was used as the surface layer. The MGO substrate prepared according to Example 2 was bonded to a cut marble plane by using a polyurethane adhesive, and after 15 minutes of curing, the marble with the MGO substrate was cut off to obtain a marble surface combined with the MGO substrate, wherein the marble surface had a thickness of 0.5 mm, and the MGO substrate had a thickness of 3 mm; and the marble surface combined with the MGO composite board were taken out and subjected to polishing and UV to obtain the reinforced and toughened MGO composite board.

### Example 9

A reinforced and toughened MGO composite board included a surface layer and a substrate, and yellow poplar veneer with a thickness of 0.6 mm was used as the surface layer. The MGO substrate prepared according to the second Example is bonded to a veneer plane by using a polyurethane adhesive, and after 15 minutes of curing, a semi-product was obtained; and then the semi-product was subjected to sanding and UV or coloring and UV, cutting and slotting to obtain the reinforced and toughened MGO composite board, wherein the MGO substrate is 3 mm.

### Example 10

A reinforced and toughened MGO composite board included a surface layer and a substrate, and a fireproof board was used as the surface layer. The fireproof board was prepared by the following steps that: an alkali-free glassfiber surface mat was immersed in a mixed resin containing melamine resin and urea-formaldehyde resin in a mass ratio of 1:1, and soaked for 130 min, and then the glass surface mat was taken out and subjected to hot-press molding with melamine decorative paper by the multi-ply plywood hot press to obtain the fireproof board.

Then, the obtained fireproof board was bonded to two side surfaces of the substrate prepared in the Example 2 by using a polyurethane adhesive to obtain the reinforced and toughened MGO composite board.

### Example 11

A reinforced and toughened MGO composite board included a surface layer and a substrate, and a fireproof board was used as the surface layer. The fireproof board was prepared by the following steps that: non-woven fabric was immersed in a mixed resin containing melamine resin and urea-formaldehyde resin in a mass ratio of 1:1, and soaked for 130 min, and then the non-woven fabric was taken out and subjected to hot-press molding with melamine decorative paper under a temperature of 150° C. and a pressure of 16 MPa to obtain the fireproof board.

Then, the obtained fireproof board was bonded to two side surfaces of the substrate prepared in the Example 2 by using a polyurethane adhesive to obtain the reinforced and toughened MGO composite board.

Test results of the reinforced and toughened MGO composite boards of Examples 8 to 11 are shown in the table below.

TABLE 6
Test Results of Reinforced and Toughened MGO Composite Boards

| | | | | | | Screw | | |
|---|---|---|---|---|---|---|---|---|
| | | Static | | | Surface | holding | | |
| Detection | Apparent | bending | Bending | Impact | abrasion | capability | Slotting | |
| item | morphology | strength | strength | strength | resistance | of board | depth | Incombustibility |
| Example 8 | No cracking | 34 Mpa | 37 Mpa | 26 kJ/m² | AC3 | 41 N/m | 176 mm | Grade A |
| Example 9 | No cracking | 37 Mpa | 38 Mpa | 27 kJ/m² | AC3 | 40 N/m | 180 mm | Grade A |
| Example 10 | No cracking | 45 Mpa | 57 Mpa | 41 kJ/m² | AC5 | 45 N/m | 186 mm | Grade A |
| Example 11 | No cracking | 46 Mpa | 58 Mpa | 44 kJ/m² | AC5 | 46 N/m | 189 mm | Grade A |

As can be seen from the above data, the strength of the reinforced and toughened MGO composite board prepared by the preparation method is obviously increased; meanwhile, the composite boards prepared in Examples 8 to 11 all have an abrasion resistance of up to higher than AC3 and an incombustibility of grade A.

The embodiments are merely illustrative of the application and are not intended to be limiting of the application, and modifications may be made to the embodiments by those skilled in the art, after reading the description, as required without involving any inventive contribution and are, however, to be protected by the patent law, provided they come within the scope of the appended claims.

What is claimed is:

1. A reinforced and toughened MGO substrate, comprising
a middle layer, and
fiber layers on upper and lower surfaces of the middle layer,
wherein the fiber layers are glassfiber surface mats, and the middle layer is prepared from a forming agent, a lightweight filler, a modifier and water in parts by weight as follows: 34-45 parts of light burned magnesium oxide, 23-30 parts of magnesium sulfate heptahydrate, 8-10 parts of granulated lignocellulose, 4-6 parts of xylem fiber, 0.5-2 parts of the modifier, and 18-26 parts of water; the modifier being obtained by mixing citric acid, anhydrous sodium sulfate, dihydrogen phosphate and phosphoric acid in a mass ratio of 10:3:1:6.

2. The reinforced and toughened MGO substrate according to claim 1, wherein the dihydrogen phosphate is any one selected from the group consisting of magnesium dihydrogen phosphate, and sodium dihydrogen phosphate.

3. The reinforced and toughened MGO substrate according to claim 1, wherein the light burned magnesium oxide has a content of magnesium oxide of >85% and a content of reactive magnesium oxide of >65%.

4. The reinforced and toughened MGO substrate according to claim 1, wherein the granulated lignocellulose has a fineness of 20-60 mesh and a moisture content of 0.5-10%, and the xylem fiber has a fiber length of 3-12 mm and a moisture content of 0.5-10%.

5. The reinforced and toughened MGO substrate according to claim 1, wherein the glassfiber surface mat is an alkali-free glassfiber surface mat which is formed by bonding randomly oriented glassfiber filaments with resin and curing, and the glassfiber filaments have a mass content of 30-100 g/m² and a length of >50 mm.

6. A preparation method of the reinforced and toughened MGO substrate according to claim 1, comprising the following steps of:
S1, uniformly stirring magnesium sulfate heptahydrate with water to obtain a magnesium sulfate heptahydrate solution;
S2, uniformly blending and stirring light burned magnesium oxide with the magnesium sulfate heptahydrate solution prepared in the step S1, and then sequentially adding a modifier, granulated lignocellulose and xylem fiber, and performing stirring for mixing to obtain magnesium oxysulfate cement;
S3, laying a glassfiber surface mat into a mold, spreading the magnesium oxysulfate cement prepared in the step S2 onto the glassfiber surface mat, performing flattening, laying another glassfiber surface mat on a surface of the magnesium oxysulfate cement, performing flattening until the surface of the glassfiber mat is uniformly permeated by a slurry, and putting the obtained material in a curing room with a temperature of 20-30° C. and a humidity of 40-60% for 2-6 h to obtain a primary cured semi-finished product;
S4, taking out the primary cured semi-finished product prepared in the step S3 from the curing room, performing flattening and exhausting; and taking out and putting the flattened and exhausted primary cured semi-finished product in the curing room with a temperature of 25-30° C. and a humidity of 40-50% for 3-5 days to obtain a secondary cured semi-finished product; and
S5, taking out the secondary cured semi-finished product prepared in the step S4 from the curing room, and performing trimming, cutting and polishing; and then putting the polished secondary cured semi-finished product in the curing room with a temperature of 25-30° C. and a humidity of 40-50% for 5-12 days to obtain a shaped substrate.

7. A reinforced and toughened MGO composite board, comprising
a surface layer and a substrate,
wherein the substrate adopts the reinforced and toughened MGO substrate according to claim 1, and the surface layer is any one selected from the group consisting of marble, wood veneer, and a fireproof board.

8. The reinforced and toughened MGO composite board according to claim 7, wherein the fireproof board is prepared by the following steps of: immersing a glassfiber surface mat in resin for 120-150 min, taking out the glassfiber surface mat, and performing hot-press molding on the glassfiber surface mat with melamine decorative paper under a temperature of 130-170° C. and a pressure of 10-21 MPa.

9. The reinforced and toughened MGO composite board according to claim 7, wherein the fireproof board is prepared by the following steps of: immersing a non-woven fabric in resin for 120-150 min, taking out the non-woven fabric, and performing hot-press molding on the non-woven fabric with melamine decorative paper under a temperature of 130-170° C. and a pressure of 10-21 MPa.

10. The reinforced and toughened MGO composite board according to claim 8, wherein the resin includes one or both of melamine resin and urea-formaldehyde resin.
